(19) United States
(12) Patent Application Publication
(10) Pub. No.: US 2019/0299041 A1
(43) Pub. Date: Oct. 3, 2019

(54) A DEVICE FOR DELIVERING A PRESSURIZED MATERIAL

(71) Applicant: ARIANEGROUP SAS, PARIS (FR)

(72) Inventor: Raphaël TEOLDI, SAUCATS (FR)

(21) Appl. No.: 16/337,234

(22) PCT Filed: Sep. 27, 2017
(86) PCT No.: PCT/FR2017/052600

§ 371 Date: Mar. 27, 2019

(30) Foreign Application Priority Data
Sep. 28, 2016 (FR) 1659164

(51) Int. Cl. A62C 13/22; A62C 35/02; B65D 83/34; B65D 83/64; B05B 15/55; B05B 7/00; B05B 9/08; B65D 83/50

(52) U.S. Cl. CPC A62C 13/22; A62C 35/023; B65D 83/34; B65D 83/643; B65D 83/50; B05B 7/0006; B05B 9/0838; B05B 9/0844; B05B 15/55

(57) ABSTRACT

A device for dispensing a pressurized material, includes a body defining a pressurizing chamber containing a gas generator, a tank for containing the material that is to be delivered, and a piston, the gas generator being configured so that when it is triggered it causes the device to pass from a material-storage, first configuration to an end-of-material-dispensing, second configuration. In the first configuration, the piston is held in position in the body by an elastically deformable holder element extending axially, that is secured to the first end wall. The piston is held stationary relative to the first end wall by a holding force from the holder element. When the gas generator is triggered, it exerts a force on the piston that opposes the holding force to enable the piston to move by releasing the first end wall and thus causing the device to pass from the first to second configuration.

### BACKGROUND OF THE INVENTION

The present invention relates to the general field of devices for delivering a material pressurized by a pyrotechnic gas generator. More particularly, the present invention relates to a device comprising a body defining two chambers that are separated in sealed manner by a piston, one of the chambers being suitable for being pressurized by the gas generator, and the other forming a tank for the material that is to be delivered.

Prior to any activation of the pyrotechnic gas generator present in such devices, the piston is generally positioned inside the cylindrical body beside the gas generator and bearing mechanically against the gas generator, e.g. by means of pegs positioned on one end of the gas generator.

When the device is exposed to high temperatures, the fluid stored in the tank may expand and subject the piston to stress, which can lead to the piston being damaged. In order to avoid that, a calibrated volume of air is generally provided inside the tank in order to compensate for such expansion. While the device is being transported, it may also be subjected to high levels of vibration. Such vibration can lead to the system being damaged. Specifically, the piston may move a little inside the device, in particular because of the presence of the calibrated volume of air in the tank, and can strike against the gas generator. Furthermore, the impact caused by the piston on the gas generator can damage the pyrotechnic charge that it contains, which can lead to problems in terms of the safety and the reliability of the device. Finally, such vibration may reduce the sealing that exists between the piston and the body of the device, which is not desirable.

There therefore exists a need for a device for delivering a pressurized material that is reliable and that can withstand high levels of vibration when it is in a configuration for storing the material, and in particular while it is being transported.

### OBJECT AND SUMMARY OF THE INVENTION

The present invention thus has a main object of mitigating such drawbacks by proposing a device for dispensing a pressurized material, the device comprising a first end wall, a second end wall provided with an outlet port, and a body extending axially between the first end wall and the second end wall, the body defining a pressurizing chamber containing a gas generator fastened to the first end wall, and a tank for containing the material that is to be delivered and that is defined by the second end wall, the device further comprising a piston configured to move inside the body, the piston separating the pressurizing chamber from the tank, the gas generator being configured so that when it is triggered it causes the device to pass from a material-storage, first configuration to an end-of-material-dispensing, second configuration. In the first configuration, the piston is held in position in the body by a holder element extending axially, said holder element being secured to the first end wall and the piston being held stationary relative to the first end wall by a holding force provided by the holder element. The gas generator is configured so that when triggered it exerts a force on the piston that opposes the holding force so as to enable the piston to move by releasing the first end wall and thus causing the device to pass from the first configuration to the second configuration.

The device of the invention is remarkable because of the presence of a holder element that extends axially, being connected firstly to the piston and secondly directly or indirectly to the first end wall, which serves to hold the piston stationary when the device is in the first configuration. Nevertheless, the holder element is configured to allow the piston to be released when the gas generator is triggered. The axial direction corresponds to the axis connecting the first end wall to the second end wall of the device, this axis generally corresponding to the travel direction of the piston inside the body. When the device is in a first configuration for storing the material, i.e. in its configuration prior to triggering the pyrotechnic gas generator, the holder element serves to hold the piston in position inside the body. The term “hold the piston in position inside the body” should be understood that the piston cannot move inside the body of the device, and in particular cannot move axially. As a result, when the device is subjected to vibration or to impacts, the piston cannot strike against the pyrotechnic gas generator and the device is not damaged. Thereafter, when the gas generator is triggered, i.e. when the device passes from the first configuration to the second configuration, the gas generator is configured so that the piston is released and can then move inside the body. It is possible for the piston to be released because of the force that is exerted on the piston by the pressurized gas released by the gas generator in the pressurizing chamber. This force exerted by the gas on the piston must therefore be greater than the holding force provided by the holder element.

By way of example, the holding force, i.e. the minimum force that needs to be exerted on the piston for it to be released and capable of moving inside the body of the device, may for example be selected as a function of the maximum acceleration due to the impacts to which the device might be subjected, as a function of the weight of the piston, and as a function of the weight of fluid stored in the tank. In summary, the holding force needs to be strictly greater than the forces that are exerted in the first configuration on the piston under conditions of impacts or vibration. In addition, the holding force must not be greater than the maximum force exerted by the piston by the gas under pressure released by the pyrotechnic gas generator after it has been triggered. Selecting this holding force can thus serve to determine the sizing of the holder element and to select the material from which it is made in appropriate manner.

The holding force as defined above may be considered as a friction force defined between the holder element and the piston and/or between the holder element and a zone secured to the first end wall of the device. The friction force is the force that needs to be applied to cause the two elements that are in contact with each other to slide relative to each other. The friction force between the holder element and the piston may thus be different from the friction force between the holder element and the zone that is secured to the first end wall. Advantageously, the friction force between the holder element and the piston may be strictly less than the friction force between the holder element and the zone secured to the first end wall. As a result, after the gas generator has been triggered, the holder element may remain fastened to the zone that is secured to the first end wall.

In particular, when the device is in the first configuration, the holder element exerts a clamping force resulting from its contact with the piston and/or with a zone secured to the first end wall. The zone secured to the first end wall may be a portion of said first end wall, or in a variant it may be a zone of an element that is secured to the first end wall, e.g. the pyrotechnic gas generator fastened to the first end wall.

In an embodiment, in the first configuration, the piston may include a housing, e.g. a blind hole, that co-operates with the holder element, the clamping force being exerted in said housing.

The holder element is elastically deformable and the clamping force results from the elasticity of the holder element. Such an elastically deformable holder element enables the device to be reused after it has been triggered since the holder element is not broken as a result of the triggering, unlike a screw which would need to break, for example. In addition, putting the elastically deformable holder element into place is easier than using a screw since the holder element can be inserted into the housing without screwing.

By way of example, the holder element may be a split tube, such as an elastic pin. Under such circumstances, in order to vary the above-defined clamping force, it is possible to act on the diameter of the split tube or on its material. When the holder element is received in a housing provided in the piston, in the first end wall, or in the pyrotechnic gas generator, the size of the housing may also serve to adapt the clamping force.

In an embodiment, when the device is in the first configuration, a first portion of the holder element may be fastened directly to the gas generator and a second portion of the holder element may be fastened directly to the piston.

In an embodiment, when the device is in the first configuration, a first portion of the holder element may be fastened directly to the first end wall, and a second portion of the holder element may be fastened directly to the piston.

In this embodiment, when the piston includes a housing co-operating with the holder element and the clamping force is exerted in said housing, the piston may include a pressure application portion extending transversely relative to the axis of the body, the housing being present in said pressure application portion.

In an embodiment, the piston may be provided with a skirt extending towards the first end wall, the second portion of the holder element being fastened directly to the skirt.

In an embodiment, the holder element may be integral with the piston, with the first end wall, or with the pyrotechnic gas generator.

The device may have a plurality of holder elements distributed around the axis of the body. For example, the device may have three holder elements. In a variant, the device may have a single holder element optionally centered on that axis of the body.

The invention also provides an extinguisher comprising a device for dispensing a pressurized material as described above, the tank of said device containing an extinguishing agent. In a variant, a lubricator device may likewise comprise a device for dispensing a pressurized material as described above, the tank in said device containing a lubricating oil.

### BRIEF DESCRIPTION OF THE DRAWINGS

Other characteristics and advantages of the present invention appear from the following description made with reference to the accompanying drawings, which show embodiments having no limiting character. In the figures:

FIG. 1 shows a delivery device in a first embodiment of the invention in the first configuration;

FIG. 2 is a section view of the piston of the FIG. 1 device through a holder element;

FIG. 3 shows an example of the holder element constituted by a split tube;

FIG. 4 is an exploded view showing how the holder elements are positioned on the piston and the gas generator of the FIG. 1 device;

FIG. 5 shows the FIG. 1 device in section after triggering the gas generator, i.e. while it is passing from the first configuration to the second configuration; and

FIG. 6 shows a delivery device in a second embodiment of the invention.

### DETAILED DESCRIPTION OF THE INVENTION

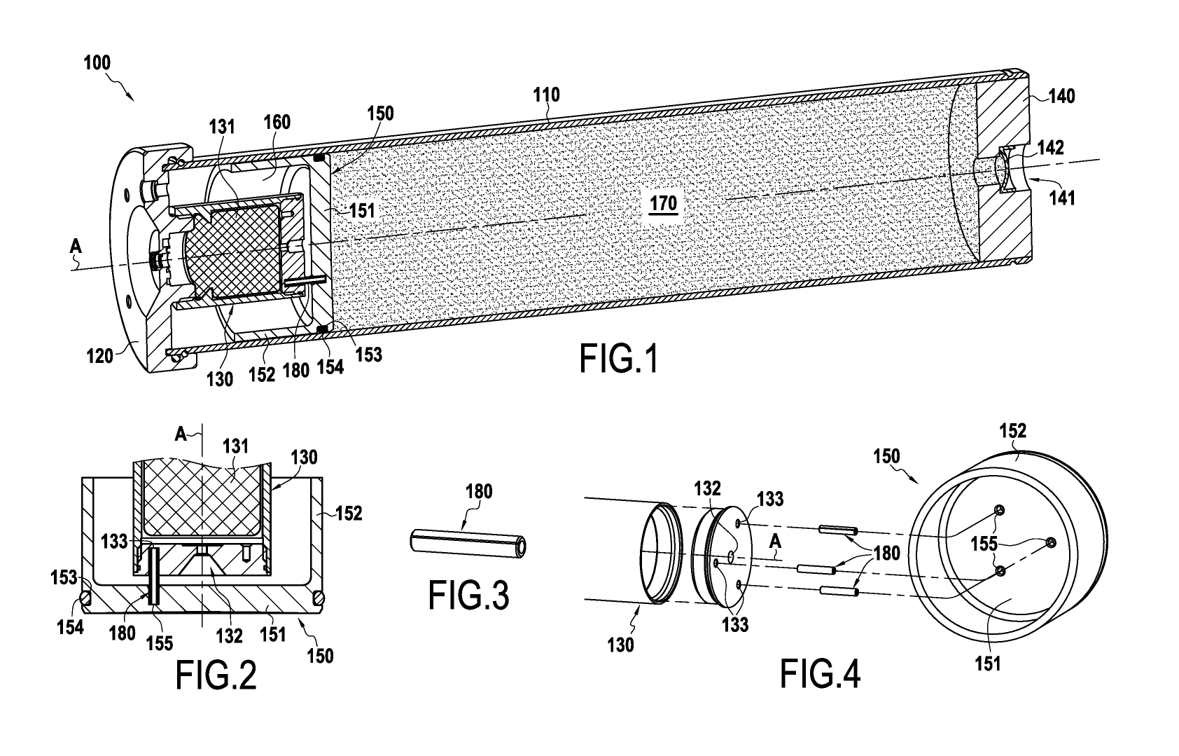

FIG. 1 shows a device 100 for delivering a pressurized material in a first embodiment of the invention, the device being shown in a first configuration corresponding to the configuration for storing material in the device 100. The device 100 has an elongate body 110 of cylindrical shape that is centered on an axis A and that extends along that axis. The body 110 of the device is closed at a first end by a first end wall 120 having a pyrotechnic gas generator 130 fastened thereto, and at a second end by a second end wall 140. A piston 150 is present inside the body 110. The piston 150 defines two chambers inside the body 110, which chambers are separated from each other in sealed manner by said piston 150, one of the chambers forming a pressurizing chamber 160 in which the gas generator 130 is present, and the other forming a tank 170 storing a material that is to be delivered by the device 100. By way of example, the material that is to be delivered may be a liquid, or in a variant it may be a powder material.

In the example shown, the pyrotechnic gas generator 130 fastened to the first end wall 120 comprises a pyrotechnic charge 131 that, on combustion, generates gas for pressurizing the pressurizing chamber 160. The gas generator 130 has an opening 132 (FIG. 2) centered on the axis A and including a flared portion through which the gas from the combustion of the charge 131 can reach the pressurizing chamber 160. Such a pyrotechnic gas generator 130 is itself known, and is not described in greater detail herein.

The second end wall 140 of the device 100 is provided with an outlet port 142, which in the example shown is constituted by a through hole formed in the second end wall 140. In the first configuration shown herein, the outlet port 141 is obstructed by a membrane 142 that is configured to break when a determined pressure threshold in the tank 170 is exceeded in order to deliver the material pressurized in that way.

The piston 150 is of cylindrical shape, and comprises a pressure application portion 151 in the form of a disk that extends transversely relative to the axis A, together with a cylindrical skirt 152 that extends from the portion 151 towards the first end wall 120. The portion 151 has a groove 153 containing a toroidal gasket 154 that provides sealing between the pressurizing chamber 160 and the tank 170.

The device 100 also has a plurality of holder elements that are constituted by split tubes 180 in the example shown. Such a split tube 180 is shown in perspective in FIG. 3. In this example, a split tube 180 is a hollow cylinder that a has a slot along its entire length (a longitudinal slot). The split tube 180 may be compressed radially and when it is compressed in that way it exerts a radial force. In this embodiment, each split tube 180 is received at a first end in a blind hole forming a housing 133 provided in the gas generator 130, and at a second end it is received in a blind hole forming a housing 155 provided in a portion 151 of the piston 150. Each of the housings 133, 155 opens out into the pressurizing chamber 160. In this example each housing 133 is situated facing a respective housing 155. Thus, in the first configuration, the holder element connects the gas generator 130 directly with the piston 150, the gas generator 130 itself being secured to the first end wall 120.

Each split tube 180 extends along an axis parallel to the axis A of the body 110 of the device 100. In the first configuration of the presently-described device, the split tubes 180 present a degree of resilience and they exert a clamping force in the housings 133 and 155. These clamping forces serve to hold the piston 150 in position in the device 100 in the first configuration, and together they define a holding force that opposes any movement of the piston 130 in the body 110. The connections between each split tube 180 and the piston 150, and between each split tube 180 and the gas generator 130 are reversible, i.e. each split tube 180 can be removed from a housing 133 or 155 by exerting a force on the split tube 180 that opposes the clamping force associated with each of the housings 133 and 155. When assembling the device 100, the split tubes 180 may be inserted by force into the housings 133 and 155. In the example shown, in the first configuration, the portion 151 of the piston 150 and the gas generator 130 are not in contact with each other, i.e. the split tubes 180 are of such a size as to leave a gap between the portion 151 and the gas generator 130 so as to further reduce any risk of the piston 150 striking the gas generator 130 in the event of impacts or vibration.

FIG. 4 is an exploded view showing: a portion of the gas generator 130 into which the opening 132 opens out and having three housings 133 present therein, three split tubes 180, and the piston 150 having three housings 155 in its portion 151. In this example, it can be seen that the split tubes 180 are distributed around the axis A of the body 110 of the device 100.

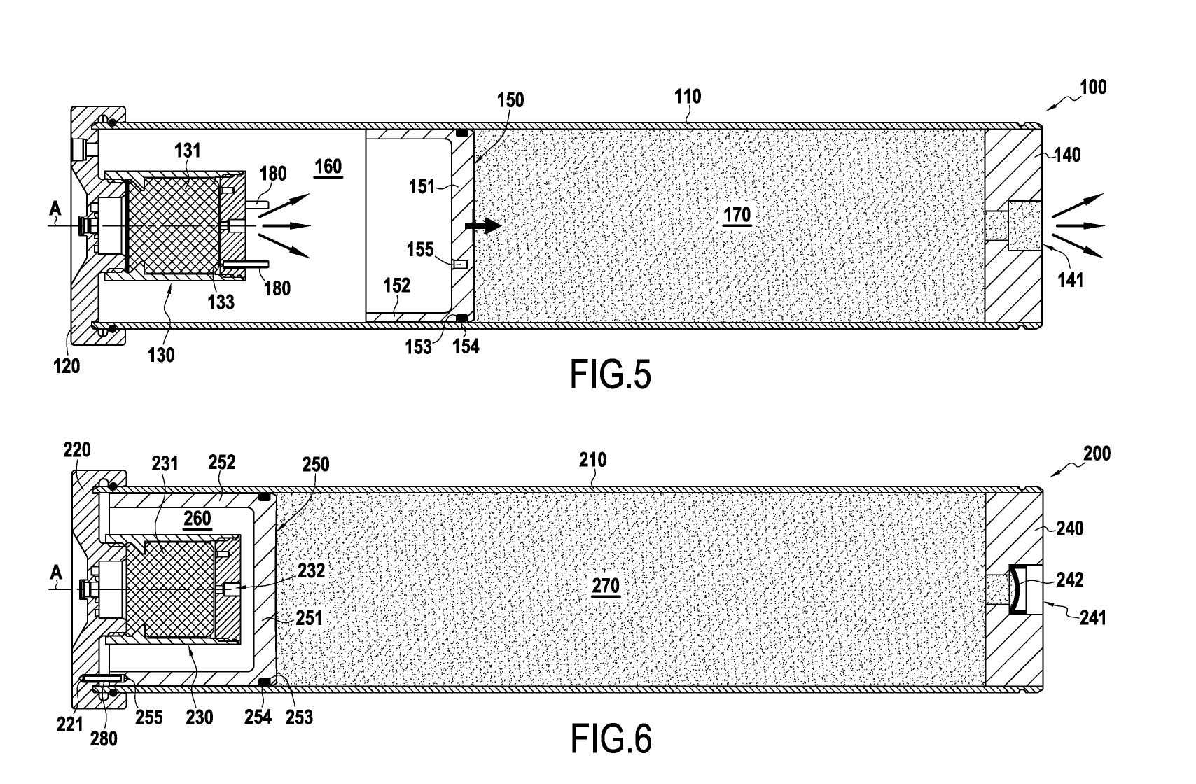

FIG. 5 shows the above-described device 100 while it is passing from the first configuration to a second configuration at the end of delivering the material. The gas generator 130 has just been triggered, gas has pressurized the pressurizing chamber 160, and it exerts a force on the piston 150. The force exerted by the gas on the piston 150 is such that the piston 150 has been able to separate from the split tubes 180 by the split tubes 180 sliding in housings 155, and has then been able to move in the body 110 so as to deliver the material contained in the tank 170 through the outlet port 141. In order to enable the piston 150 to be released from the split tubes 180, the force exerted by the gas must be strictly greater than the holding force provided by the split tubes 180, i.e. in this example the sum of the clamping forces exerted by the split tubes 180 in the housings 155 of the piston 150. In the example shown, after the gas generator 130 has been triggered, the split tubes 180 remain in the housings 133 provided in the gas generator 130. For this purpose, it is ensured that the clamping force between each split tube 180 and the corresponding housing 155 in the piston 150 is strictly less than the clamping force that exists between each split tube 180 and the corresponding housing 133 in the gas generator 130.

In a variant that is not shown, each split tube 180 could remain fastened to the piston 150 after the gas generator 130 has been triggered. Under such circumstances, the clamping force between each split tube 180 and the corresponding housing 155 in the piston 150 is strictly greater than the clamping force that exists between each split tube 180 and the corresponding housing 133 in the gas generator 130.

FIG. 6 shows a device 200 in a second embodiment of the invention, in the first configuration corresponding to the configuration for storing the material in the device. Corresponding reference signs between the devices 100 and 200 designate characteristics that are identical. The operation of the device 200 in FIG. 6 is identical to the operation of the above-described operation of the device 100. As above, the device 200 comprises a cylindrical body 210 extending along an axis A between a first end wall 220 and a second end wall 240. A pyrotechnic gas generator 230 is fastened to the first end wall 220, and the second end wall 240 is provided with an outlet port 241 obstructed by a membrane 242. The body 210 includes a pressurizing chamber 260 into which a gas generator 230 opens out, and a tank 270 that stores the material for delivering, the chamber 260 and the tank 270 likewise being separated by a piston 250.

In the presently-described example, the piston 250 when in the first configuration is held in position in the body 210 by three split tubes 280 (only one tube 180 is visible in the section shown). In the above-described device 100, the holder elements constituted by the split tubes 180 connect the piston 150 indirectly to the first end wall 120, i.e. via another part that is secured to the first end wall 120 and that is constituted specifically by the gas generator 130. In the example of FIG. 6, the split tubes 180 connect the piston 150 directly to the first end wall 220. In this example, the skirt 252 of the piston 250 presents blind holes at its end facing the first end wall 220, which holes form the housings 255. Facing each housing 255 there is a blind hole forming a housing 221 that is made in the first end wall 220. The housings 221 and 255 all open out into the pressurizing chamber 260. Each split tube 280 is thus received at a first end in a housing 221 of the first end wall 220, and at a second end in a housing 255 in the skirt 252. As in the above example, it is advantageous, in the first configuration, to ensure that a non-zero gap is present between the gas generator 230 and the portion 251 of the piston in order to reduce any risk of the gas generator 230 being damaged by the piston 250 in the event of impacts or vibration.

It should be observed that the invention is not limited to the two embodiments described above. In particular, the holder elements may be of shapes other than that shown, so long as they extend generally in the direction given by the axis of the body of the device, i.e. providing they present a non-zero component along that axis. By way of example, each holder element may present two ends, each of which is parallel to the axis of the body, together with a portion between the two ends that is not parallel to the axis of the body.

The invention may also apply to a device comprising a body having a shape that is other than cylindrical, or that includes a piston without a skirt.

In an embodiment that is not shown, one or more holder elements may be fastened directly to the first end wall of the device at one end and to the pressure application portion of the piston at another end. In yet other embodiments that are not shown, the holder element may be integral with the piston, with the first end wall, or with the pyrotechnic gas generator, i.e. it may form a portion in relief on the piston, on the first end wall, or on the gas generator, that is to co-operate with a housing so as to hold the piston while the device is in the first configuration.

1. A device for dispensing a pressurized material, the device comprising a first end wall a second end wall provided with an outlet port, and a body extending axially between the first end wall and the second end wall, the body defining a pressurizing chamber containing a gas generator fastened to the first end wall, and a tank for containing the material that is to be delivered and that is defined by the second end wall, the device further comprising a piston configured to move inside the body, the piston separating the pressurizing chamber from the tank, the gas generator being configured so that when the gas generator is triggered the gas generator causes the device to pass from a material-storage, first configuration to an end-of-material-dispensing, second configuration,
wherein, in the first configuration, the piston is held in position in the body by an elastically deformable holder element extending axially, said holder element being secured to the first end wall and the piston being held stationary relative to the first end wall by a holding force provided by the holder element, the holder element exerting a clamping force that results from its contact with the piston and/or with a zone secured to the first end wall, the clamping force resulting from the elasticity of the holder element, and wherein
the gas generator is configured so that when triggered the gas generator exerts a force on the piston that opposes the holding force so as to enable the piston to move by releasing the first end wall and thus causing the device to pass from the first configuration to the second configuration.

2. A device according to claim 1, wherein, in the first configuration, the piston has a housing co-operating with the holder element, the clamping force being exerted in said housing.

3. A device according to claim 1, wherein the holder element is a split tube.

4. A device according to claim 1, wherein, when the device is in the first configuration, a first portion of the holder element is fastened directly to the gas generator and a second portion of the holder element is fastened directly to the piston.

5. A device according to claim 1, wherein, when the device is in the first configuration, a first portion of the holder element is fastened directly to the first end wall, and a second portion of the holder element is fastened directly to the piston.

6. A device according to claim 2, wherein the piston includes a pressure application portion extending transversely relative to the axis of the body, the housing being present in said pressure application portion.

7. A device according to claim 5, wherein the piston is provided with a skirt extending towards the first end wall, the second portion of the holder element being fastened directly to the skirt.

8. A device according to claim 1, having a plurality of holder elements distributed around the axis of the body.

9. An extinguisher including a device for dispensing a pressurized material according to claim 1, the tank of said device containing an extinguishing agent.
